(19) United States
(12) Patent Application Publication
(10) Pub. No.: US 2017/0104392 A1
(43) Pub. Date: Apr. 13, 2017

(54) ELECTRIC COMPRESSOR

(71) Applicant: KABUSHIKI KAISHA TOYOTA JIDOSHOKKI, Kariya-shi (JP)

(72) Inventors: Takuro MIZUNO, Kariya-shi (JP); Tatsuya KOIDE, Kariya-shi (JP); Junya YANO, Kariya-shi (JP); Akio FUJII, Kariya-shi (JP); Yusuke KINOSHITA, Kariya-shi (JP); Tetsuya YAMADA, Kariya-shi (JP); Kenji MOMMA, Kariya-shi (JP)

(73) Assignee: KABUSHIKI KAISHA TOYOTA JIDOSHOKKI, Kariya-shi (JP)

(21) Appl. No.: 15/286,654

(22) Filed: Oct. 6, 2016

(30) Foreign Application Priority Data
Oct. 9, 2015 (JP) 2015-201021

(51) Int. Cl. H02K 11/01; H02K 11/33; H02K 5/04; F04C 18/02

(52) U.S. Cl. CPC H02K 11/01; F04C 18/0215; H02K 11/33; H02K 5/04; F04C 2210/26; F04C 2240/40

(57) ABSTRACT

The electric compressor includes a housing having electrical conductivity, an inverter, a cover having electrical conductivity, a sealing portion, and a shielding portion having electrical conductivity. The cover is attached to the housing, thereby defining an accommodating space in which the inverter is accommodated. The sealing portion has a main body portion made of resin and a metal portion having electrical conductivity. The sealing portion is provided in a gap between the housing and the cover. The shielding portion is joined to the metal portion and electrically grounded. The metal portion is provided in the accommodating space, and has an outer circumferential edge embedded in the main body portion. The shielding portion is arranged so as to face a third surface of the main body portion and so as to extend from the metal portion toward at least one of the first surface and the second surface.

This nonprovisional application is based on Japanese Patent Application No. 2015-201021 filed on Oct. 9, 2015, with the Japan Patent Office, the entire contents of which are hereby incorporated by reference.

### BACKGROUND OF THE INVENTION

Field of the Invention

The present invention relates to an electric compressor.

Description of the Background Art

As a compressor mounted in a vehicle such as a hybrid vehicle, an electric vehicle or a fuel cell vehicle, there is a recently developed electric compressor with which an inverter for driving an electric motor is integrated for the purpose of size reduction. Such an electric compressor has a housing in which an electric motor and a compression mechanism are incorporated. The inverter is accommodated in a space formed by the housing and an inverter cover.

Japanese Patent Laying-Open No. 2007-224902 discloses a configuration in which a gap between a housing and an inverter cover is filled with a sealing member formed by integrally providing a rubber material on the outer periphery of the core metal (shape retaining portion). Such a configuration can increase the close contact between the housing and the inverter cover. Consequently, for example, foreign matters or water can be prevented from coming through a gap between the housing and the inverter cover into the space accommodating the inverter.

When the sealing member filling the gap between the housing and the inverter cover is made of an insulation member like a rubber material, an electromagnetic noise passes through the sealing member. Consequently, the electromagnetic noise from the inverter may be emitted to the outside, or the electromagnetic noise may intrude from the outside of the electric compressor into an inverter unit. Examples of electromagnetic noises coming from the outside may be an electromagnetic noise and a radio wave generated from electronic components mounted in a vehicle, or a radio wave from a smart phone.

If such emission and intrusion of electromagnetic noises are not suppressed, the EMC (Electro-Magnetic Compatibility) of the electric compressor may deteriorate.

### SUMMARY OF THE INVENTION

The present invention has been made to solve the above-described problems. An object of the present invention is to provide an electric compressor with improved EMC.

An electric compressor according to the present invention includes: a housing having electrical conductivity; a compression unit; an electric motor; an inverter; a cover having electrical conductivity; a sealing portion; and at least one shielding portion having electrical conductivity. The compression unit is accommodated in the housing. The electric motor is accommodated in the housing and configured to rotate the compression unit. The inverter configured to drive the electric motor. The cover is attached to the housing to define an accommodating space in which the inverter is accommodated. The sealing portion includes a main body portion made of resin and a metal portion having electrical conductivity. The sealing portion is provided between the housing and the cover. The sealing portion has a main body portion made of resin and a metal portion having electrical conductivity. The at least one shielding portion is joined to the metal portion and electrically grounded. The main body portion has a first surface in contact with the cover, a second surface in contact with the housing, and a third surface located between the first surface and the second surface and facing the accommodating space. The metal portion is provided in the accommodating space and has an outer circumferential edge embedded in the main body portion. The at least one shielding portion is arranged to face the third surface of the main body portion and to extend from the metal portion toward at least one of the first surface and the second surface.

According to the electric compressor of the present invention, the at least one shielding portion can provide a shield against an electromagnetic noise, with the result that the EMC of the electric compressor can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing the entire configuration of an electric compressor according to an embodiment.

FIG. 2 is an enlarged view of a characteristic portion (a region R in FIG. 1) of the electric compressor in FIG. 1.

FIG. 3 is a perspective view showing arrangement of a sealing portion and a shielding portion in the first embodiment.

FIG. 4 is a perspective view showing arrangement of a sealing portion and a shielding portion in the second embodiment.

FIG. 5 is a view showing arrangement of a sealing portion and a shielding portion in another embodiment.

### DESCRIPTION OF THE PREFERRED EMBODIMENTS

The embodiments of the present invention will be hereinafter described in detail with reference to the accompanying drawings, in which the same or corresponding components are designated by the same reference characters, and description thereof will not be repeated.

### First Embodiment

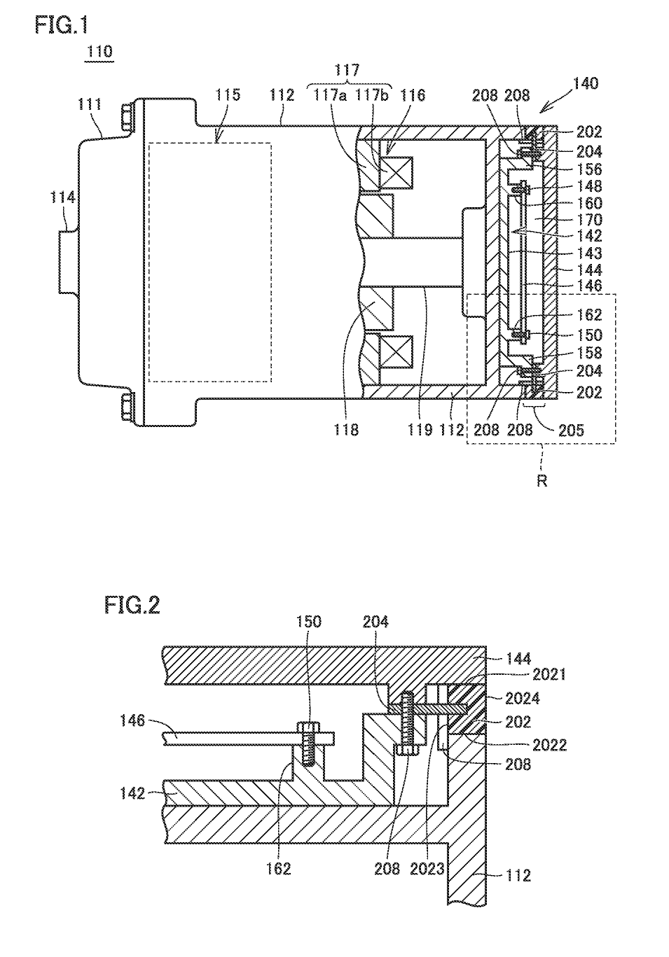

FIG. 1 is a schematic view showing the entire configuration of an electric compressor 110 according to the first embodiment. As shown in FIG. 1, the electric compressor 110 includes: a housing formed by joining a cover-shaped discharge housing 111 made of aluminum (made of a metal material) to a suction housing 112 having a bottomed cylindrical shape and made of aluminum (made of a metal material); a compression unit 115 and an electric motor 116 that are accommodated in the suction housing 112; and an inverter unit 140 attached integrally to the suction housing 112.

On the bottom surface side of the outer circumferential surface of the suction housing 112, a suction port (not shown) is formed, to which an external refrigerant circuit (not shown) is connected. A discharge port 114 is formed on the cover of the discharge housing 111 and connected to the external refrigerant circuit. The suction housing 112 accommodates a compression unit 115 for compressing a refrigerant, and an electric motor 116 for driving the compression unit 115. Although not shown, the compression unit 115 is configured to include: a fixed scroll fixed inside the suction housing 111, a movable scroll arranged to face the fixed scroll, and a compression chamber formed by the fixed scroll and the movable scroll.

A stator 117 is fixed to the inner circumferential surface of the suction housing 112. The stator 117 is configured to include a stator core 117a fixed to the inner circumferential surface of the suction housing 112, and a coil 117b wound around teeth (not shown) of the stator core 117a.

A rotation shaft 119 that is inserted through the stator 117 is supported so as to be rotatable inside the suction housing 112. Also, a rotor (rotator) 118 is fixed to this rotation shaft 119.

An inverter cover 144 is attached to the outer surface of the suction housing 112 on the side opposite to the discharge housing 111 in such a manner that a sealing portion 205 is interposed therebetween.

The inverter cover 144 is formed, for example, of an electrically conductive member such as an aluminum alloy. The inverter cover 144 may be formed of resin and a metal shielding portion.

An accommodating space 170 for accommodating the inverter unit 140 is defined by the suction housing 112, the inverter cover 144 and the sealing portion 205.

The inverter unit 140 is attached to the outer surface of the suction housing 112 on the side opposite to the discharge housing 111. The inverter unit 140 includes an aluminum base 142 and an inverter substrate 146 attached to the aluminum base 142.

The aluminum base 142 has a plate-shaped main body portion 143 and leg portions 156, 158, 160, and 162 that are vertically arranged so as to extend from the main body portion 143. The leg portions 160 and 162 are located on the inside relative to the leg portions 156 and 158 (radially inward with respect to the rotation shaft 119). The inverter substrate 146 is fastened by screws 148 and 150 to these leg portions 160 and 162.

The main body portion 143 of the aluminum base 142 is fixed to the suction housing 112 with an adhesive. The aluminum base 142 may be fixed to the suction housing 112 with a screw. The suction housing 112 and the aluminum base 142 are made of thermally conductive metal and in close contact with each other. Also, the aluminum base 142 and the inverter substrate 146 are thermally joined to each other. Accordingly, the aluminum base 142 serves to conduct the heat of the inverter substrate 146 to the suction housing 112 to allow heat dissipation from the inverter substrate 146.

The sealing portion 205 is arranged between the suction housing 112 and the inverter cover 144. The sealing portion 205 has a main body portion 202 and a core metal 204 as a metal portion. The core metal 204 is to retain the shape of the main body portion 202.

The main body portion 202 is, for example, made of a resin member such as a rubber material and formed in an annular shape in the present embodiment. The main body portion 202 has: a first surface 2021 that is in contact with the inverter cover 144; a second surface 2022 that is in contact with the suction housing 112; a third surface 2023 that is located between the first surface 2021 and the second surface 2022 so as to extend in a direction intersecting with the first and the second surfaces 2021, 2022 and to connect the first and the second surfaces 2021, 2022 and that corresponds to a surface facing the accommodating space 170; and a fourth surface 2024 that is located between the first surface 2021 and the second surface 2022 so as to extend in a direction intersecting with the first and the second surfaces 2021, 2022 and to connect the first and the second surfaces 2021, 2022 and that corresponds to a surface on the side opposite to the third surface 2023.

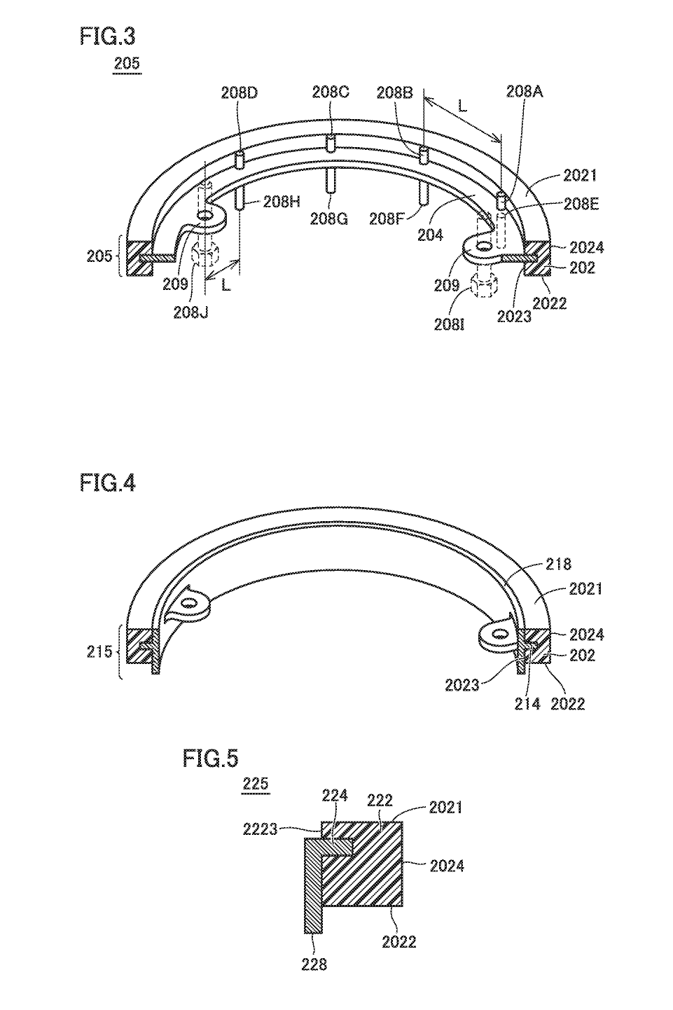

The core metal 204 is, for example, made of an electrically conductive member such as stainless steel and formed in an annular shape in the present embodiment. The core metal 204 is provided in the accommodating space 170. The outer circumferential edge of the core metal 204 is embedded in the main body portion 202. By such a configuration, the shape of the main body portion 202 is maintained by the core metal 204. The core metal 204 includes a plurality of positioning portions 209 (see FIG. 3) protruding inwardly. The positioning portion 209 is provided with a screw hole.

As shown in FIG. 1, the core metal 204 is fixed to the inverter cover 144 and the aluminum base 142 by joint-fastening of the screw between the inverter cover 144 and the leg portions 156, 158 of the aluminum base 142 with the positioning portion 209 interposed therebetween.

The positioning portion 209 is sandwiched and fixed between the aluminum base 142 and the inverter cover 144, so that the core metal 204 is electrically connected to the suction housing 112 and the inverter cover 144. In the present embodiment, the suction housing 112 and the inverter cover 144 are electrically grounded, with the result that the core metal 204 is to be also electrically grounded.

The inverter substrate 146 is accommodated in the accommodating space 170 such that the inverter substrate 146 extends in the direction orthogonal to the axial direction of the rotation shaft 119. In the first embodiment, the compression unit 115, the electric motor 116 and the inverter unit 140 are arranged in this order in the axial direction of the rotation shaft 119.

On the circuit substrate, the inverter substrate 146 includes: a drive control circuit (an inverter circuit) of the electric motor 116; and a filter circuit formed of an electromagnet coil and a capacitor, each of which is not shown. The filter circuit does not have to be provided on the circuit substrate as long as it is electrically connected to the circuit substrate.

The electric power controlled by the inverter circuit is supplied to the electric motor 116, to cause the rotor 118 and the rotation shaft 119 to rotate at the controlled rotation speed, thereby driving the compression unit 115. The compression unit 115 is driven, so that: (i) the refrigerant is sucked from the external refrigerant circuit through the suction port into the suction housing 112; (ii) the refrigerant sucked into the suction housing 112 is compressed by the compression unit 115; and (iii) the compressed refrigerant is discharged through the discharge port 114 to the external refrigerant circuit.

Since the main body portion 202 of the sealing portion 205 is made of a rubber material in this case, the electromagnetic noise passes through the main body portion 202. Accordingly, the electromagnetic noise from the inverter substrate 146 may be emitted to the outside, and the electromagnetic noise for example generated from the electronic component mounted in a vehicle may intrude into the inverter unit 140 from the outside of the electric compressor 110. If such emission and intrusion of the electromagnetic noise are not suppressed, the EMC (Electro-Magnetic Compatibility) of the electric compressor 110 may deteriorate.

In consideration of the above-described problems, a shielding portion 208 is joined to the core metal 204 of the sealing portion 205 in the first embodiment. In other words, the shielding portion 208 and the core metal 204 are electrically conductive to each other. The shielding portion 208 is joined to the core metal 204 so that it is electrically grounded. The shielding portion 208 provides a shield against the electromagnetic noise from the inverter substrate 146 and the electromagnetic noise from the outside of the inverter cover 144. The shielding portion 208 and the core metal 204 may be integrally formed.

In addition, the shielding portion 208 is arranged so as to face the third surface 2023 of the main body portion 202 and so as to extend from the core metal 204 toward at least one of the first surface 2021 and the second surface 2022. Furthermore, the shielding portion 208 is formed of an electrically conductive material and electrically grounded. With such a structure, the shielding portion 208 extends to cross the main body portion 202 so as to provide a shield against the electromagnetic noises.

FIG. 2 is an enlarged view of a characteristic portion (a region R in FIG. 1) of the electric compressor 110 in FIG. 1. FIG. 3 is a perspective view showing arrangement of a sealing portion 205 and a shielding portion 208 in the first embodiment. FIG. 3 shows approximately the half of the sealing portion 205. Also on the side opposite to the side shown in FIG. 3, the sealing portion 205 and the shielding portion 208 are arranged in the almost same manner as that shown in FIG. 3.

As shown in FIGS. 1, 2 and 3, a plurality of rod-shaped members 208A to 208H are provided at intervals from each other on the core metal 204. The rod-shaped members 208A to 208D are arranged to extend from the core metal 204 toward the first surface 2021 while the rod-shaped members 208E to 208H are arranged to extend from the core metal 204 toward the second surface 2022. Furthermore, screws 208I and 208J are provided in the positioning portion 209 of the core metal 204. The rod-shaped members 208A to 208H and the screws 208I and 208J are electrically conductive, are electrically grounded, and each serves as the shielding portion 208 of the present invention.

The rod-shaped members 208A to 208H and the screws 208I and 208J are arranged on the core metal 204 at a prescribed interval L from each other. The prescribed interval L corresponds to a distance by which the electromagnetic noise from the inverter unit 140 is prevented from being emitted to the outside of the accommodating space 170. It is also desirable that the prescribed interval L is shorter than the half-wavelength of the electromagnetic noise against which a shield is required. The prescribed interval L is determined as appropriate by actual-device experiments or simulations. The intervals defined among the rod-shaped members 208A to 208H and the screws 208I and 208J do not have to be regular intervals, but the maximum interval thereof may be smaller than the prescribed interval L.

The rod-shaped members 208A to 208H in the first embodiment are in close contact with the third surface 2023 of the main body portion 202 in the sealing portion 205. In addition, the shielding portion 208 may be in contact with the suction housing 112 or the inverter cover 144. Furthermore, the shielding portion 208 does not have to be in close contact with the third surface 2023 of the main body portion 202 in the sealing portion 205.

According to the electric compressor 110 in the first embodiment as described above, the shielding portion 208 (the rod-shaped members 208A to 208H and the screws 208I and 208J) provides a shield against the electromagnetic noise from the inverter unit 140 and the electromagnetic noise from the outside of the inverter cover 144. Consequently, the EMC of the electric compressor 110 can be improved.

### Second Embodiment

The second embodiment is different from the first embodiment in that the shapes of the shielding portions are different. Since the features other than this difference are the same as those in the first embodiment, the description thereof will not be repeated.

FIG. 4 is a perspective view showing arrangement of a sealing portion 215 and a shielding portion 218 in the second embodiment. As shown in FIG. 4, the shielding portion 218 is formed in an annular shape and formed in a circular cylindrical shape in the second embodiment. The shielding portion 218 is arranged to extend from the core metal 214 toward the first surface 2021 and the second surface 2022 so as to cover the third surface 2023 of the main body portion 202. Although the outer circumferential surface of the shielding portion 218 in the second embodiment is in close contact with the third surface 2023 of the main body portion 202, it does not have to be in close contact with the third surface 2023 of the main body portion 202.

According to the electric compressor in the second embodiment as described above, the shielding portion 218 provides a shield against the electromagnetic noise from the inverter substrate 146 and the electromagnetic noise from the outside of the inverter cover 144. Consequently, the EMC of the electric compressor can be improved.

In the first and second embodiments, the shielding portion is arranged to extend toward both of the first surface 2021 and the second surface 2022. However, the shielding portion only has to be arranged to extend toward one of the first surface 2021 (the inverter cover 144) and the second surface 2022 (the suction housing 112).

FIG. 5 is a view showing arrangement of a sealing portion 225 and a shielding portion 228 in another embodiment. As shown in FIG. 5, the core metal 224 is provided so as to be located close to the first surface 2021. The shielding portion 228 is arranged to extend toward the second surface 2022 but not to extend toward the first surface 2021. On the other hand, when the core metal 224 is provided so as to be located close to the second surface 2022, the shielding portion 228 is arranged to extend toward the first surface 2021 but does not have to be arranged to extend toward the second surface 2022. If the distance between the shielding portion 228 and the inverter cover 144 or the distance between the shielding portion 228 and the suction housing 112 is equal to or less than a prescribed interval, the portion corresponding to such the distance does not have to be covered but can be shielded by the shielding portion 228 against the electromagnetic noise.

Since the core metal in each of the above-described embodiments has a shielding portion joined thereto, this core metal can serve to maintain the shape of the main body portion 202 and also can provide a shield against the electromagnetic noise from the inverter substrate 146 and the electromagnetic noise from the outside of the inverter cover 144.

Although the embodiments of the present invention have been described as above, it should be understood that the embodiments disclosed herein are illustrative and non-restrictive in every respect. The scope of the present invention is defined by the terms of the claims, and is intended to include any modifications within the meaning and scope equivalent to the terms of the claims.

What is claimed is:

1. An electric compressor comprising:
a housing having electrical conductivity;
a compression unit accommodated in the housing;
an electric motor accommodated in the housing and configured to rotate the compression unit;
an inverter configured to drive the electric motor;
a cover having electrical conductivity, the cover being attached to the housing to define an accommodating space in which the inverter is accommodated;
a sealing portion including a main body portion made of resin and a metal portion having electrical conductivity, the sealing portion being provided between the housing and the cover; and
at least one shielding portion having electrical conductivity, the at least one shielding portion being joined to the metal portion and electrically grounded,
the main body portion having a first surface in contact with the cover, a second surface in contact with the housing, and a third surface located between the first surface and the second surface and facing the accommodating space,
the metal portion being provided in the accommodating space and having an outer circumferential edge embedded in the main body portion, and
the at least one shielding portion being arranged to face the third surface of the main body portion and to extend from the metal portion toward at least one of the first surface and the second surface.

2. The electric compressor according to claim 1, wherein the at least one shielding portion and the metal portion are integrally formed.

3. The electric compressor according to claim 1, wherein
a plurality of the shielding portions each formed in a rod shape are provided,
the plurality of the shielding portions are arranged at prescribed intervals, and
the prescribed intervals each correspond to a distance by which an electromagnetic noise from the inverter is prevented from being emitted to outside of the accommodating space.

4. The electric compressor according to claim 3, wherein each of the plurality of the shielding portions is formed in a circular cylindrical shape.

5. The electric compressor according to claim 1, wherein the at least one shielding portion is formed in a cylindrical shape.

6. The electric compressor according to claim 1, wherein the main body portion is made of an elastic member.
